(19) United States
(12) Patent Application Publication
(10) Pub. No.: US 2003/0072325 A1
(43) Pub. Date: Apr. 17, 2003

(54) Method for collision management of a wireless detection system

(76) Inventors: Willi Brandli, Bergdietikon (CH); Yvo Vultier, Zurich (CH); Dietrich Gilg, Zurich (CH); Reto Schreppers, Dietikon (CH)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/280,059

(22) Filed: Oct. 25, 2002

Related U.S. Application Data
(63) Continuation of application No. PCT/EP01/00892, filed on Jan. 27, 2001.

(30) Foreign Application Priority Data
Apr. 27, 2000 (EP) EP00108905.1

(51) Int. Cl. H04Q 7/00; H04L 12/413

(52) U.S. Cl. 370/447; 370/328; 370/329; 370/445

(57) ABSTRACT

The invention relates to a method for managing collisions in a wireless detection system, wherein a plurality of portable receivers and at least one transmitter/receiver unit mounted on a vehicle are provided. Communication is of the intermittent type due to an on/off cycle. Sent call messages are first confirmed by a quittance device associated with the detection zone by means of a quittance report. The receivers respond to a received call message with an availability message that identifies the respective receiver. Before a message is sent, it is checked whether the radio medium is available. Collisions that occur are recognized by the absence of the quittance report. Communication is resumed by sending further messages at fixed intervals or at intervals that are determined by a random number generator. The inventive method provides for a complete detection of the portable receivers even when the ranges of detection overlap. The on/off cycle can be adaptively adjusted.

### CROSS REFERENCE TO RELATED APPLICATIONS

The present application is a continuation of international patent application PCT/EPO1/00892, filed 27 January, 2001 and further claims priority to European patent application EP00108905.1, filed 27 April, 2000, both of which are incorporated herein by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

A system is known from EP 0 642 096 A2 which provides for simultaneous down loading of a multiple number of portable receivers. These portable receivers are mostly developed as the so-called smart cards and can be used in electronic detection systems. Such detection systems are used for example for the registration of persons and objects. In the following such portable receivers, and in particular smart cards, are referred to as electronic tickets or in short tickets.

Tickets communicate bi-directionally with a stationary or a sending/receiving unit located in a vehicle. The unit will be hereafter referred to as “terminal”. The communication is based essentially on the two following steps: a terminal sends at least one general message—also known as a call-in or broadcast message—via which is communicated to the tickets, which are located in the detection zone, that they can transmit a presence message for identity registration indicating identity. Following this, the terminal can individually address the tickets as required and for example acknowledge the received identity. These two steps must be repeated for guaranteed complete registration of the tickets so as to guarantee a conclusive accounting.

Conditioned on the multitude of persons on a platform or in a vehicle, and possible overlays by terminals of other vehicles located in the proximity, collisions arise in the communication. A secure and guaranteed detection of the tickets is thereby endangered. Collisions in the communication happen especially on parallel rides of vehicles. Such collisions can for example be avoided by a method where the terminals and the tickets transmit a message in a time which is determined by a random generator. Such a method presupposes that the tickets are in a continually ready to receive state.

The method “slotted ALOHA”, mentioned in EP 0 642 096 A2, is based upon the concept that the receiving tickets receive can confirm a message at one of several pre-determined times. The selection of time is made by the ticket. This method also presupposes that the tickets are in a ready to receive state.

In the method set out in WO 99/36877, each ticket reduces the probability of sending out further presence messages as long as no collisions are detected and the ticket identity could be transmitted successfully. The other tickets subsequently have an increase in the probability that their identity may be again transmitted, this time successfully or another collision occurs. Such methods are referred to as “random access”. In WO 99/36877 an anti-collision method is claimed, in which the above mentioned “random access” and the “slotted ALOHA” method are combined. This anti-collision method comprises the following steps:

a) a terminal sends out a general broadcast message;

b) the tickets located in the detection zone answer with a probability of <1 (less than 1) by a presence message which contains the identity of the corresponding ticket;

c) if the terminal receives a presence message from a ticket collision-free, a communication with the corresponding ticket is set up by the terminal and the method subsequently returns to procedure step a); and

d) if the terminal receives a collision effected presence message, the method returns to procedure step a).

The probability in step b) is changed as a function of the answered broadcast messages already answered by the ticket. This method is especially appropriate for so-called proximity cards in that it presupposes a continuous coupling during the whole procedure because the interaction with such cards generally occurs via an H-field in the so-called near field area. The size of the detection zone is thereby limited.

An arrangement is known from EP 0 902 353 which allows for awakening a ticket from a power saving mode into an active status mode. A lower power consumption results and therefore enables higher autonomics. Higher autonomics from tickets provided with a source of energy is additionally obtained by an intermittent duty of the ticket's sending/receiving module. The sending/receiving module is switched on only during certain time segments to receive a message, for example in the cycle t_{CYCL}=10 s for t_{PSG}=10 ms. This results in a so called duty cycle of 1/1000 and leads to a corresponding lower power consumption. The intermittent duty results in the broadcast messages to all tickets no longer taking place at anytime. Rather, such broadcasts occur only when the sending/receiving modules located on the tickets are ready to receive. The danger of collision is thereby essentially increased. This disadvantageously effects the tickets to be registered. In addition, collisions with a neighboring sending/receiving unit can happen, for example at a parallel ride of two trains.

### SUMMARY OF THE INVENTION

An advantage of the present invention lay in a method which recognizes occurring collisions for an intermittent communication between a terminal and a multitude of portable receivers or tickets and avoids these collisions in such a way that facilitates a high communication throughput. Accordingly, the following advantages may also be realized:

i) by at least one wagon specific on/off switch cycle the tickets can also be detected in an intermittent traffic if the associated detection zones overlay

ii) repeated collisions in the communication are thereby avoided, as the tickets comprise an individual random generator for the time of sending out a message and a random value is generated from a range of values whose upper limit is monotonously increasing.

iii) repeated collisions between neighboring sending/receiving units are avoided by a dephased or a second on/off switching cycle.

iv) the on/off switching cycle of the tickets is changeable by an information sent out from the sending/receiving unit to the tickets located in the associated detection zone and can adaptively be adjusted to the corresponding application.

v) no highly accurate clock generators have to be used on the electronic tickets because a re-synchronization of the clock generator can be carried out in the pre-determined cycle by a given off information unit.

The present invention is further directed to a method for managing collisions in a wireless detection system, said system comprising a plurality of receivers having a sending receiving module and at least one sending receiving unit for intermittent communication, via an on off switching cycle within a cycle, with said receivers located in a detection zone, comprising the steps of: transmitting a broadcast message from said sending receiving unit to at least one receiver and transmitting a quittance message to said sending receiving unit from a quittance device associated with said detection zone; transmitting a presence message identifying said at least one receiver to said sending receiving unit, said message being transmitted by said at least one receiver upon receipt of said broadcast message, said message being transmitted after a time determined by a random generator; transmitting an acknowledgement message from said sending receiving unit to said at least one receiver, said acknowledgement message acknowledging receipt of said presence message; if a collision occurs in the communication between said at least one receiver and said sending receiving unit, said collision is eliminated by: repeating said step of transmitting a broadcast message if said quittance message is not received by said at least one receiver within a select cycle; and repeating said step of transmitting a presence message, at a random time generated by a random generator, if said acknowledgement message is not received by said at least one receiver within a latency time after said step of transmitting a presence message.

These and other advantages will become clear from the description and claims below.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawing, wherein:

FIG. 1 depicts a plan of a vehicle with the lay-out of a first sending unit, a second sending/receiving unit and an answering station as well as an entering and detection zone;

FIG. 2 depicts a first on/off switching cycle for the intermittent traffic of the second receiving module on an electronic ticket as well as a dephased alternative on/off switching cycle;

FIG. 3 depicts a second alternative on/off switching cycle for the intermittent traffic of the second receiving module on an electronic ticket;

FIG. 4 depicts a signal detection before sending a message; and

FIG. 5 depicts the course of the method according to the invention with a sending/receiving unit and the disclosure of a collision in the communication.

### DETAILED DESCRIPTION OF THE INVENTION

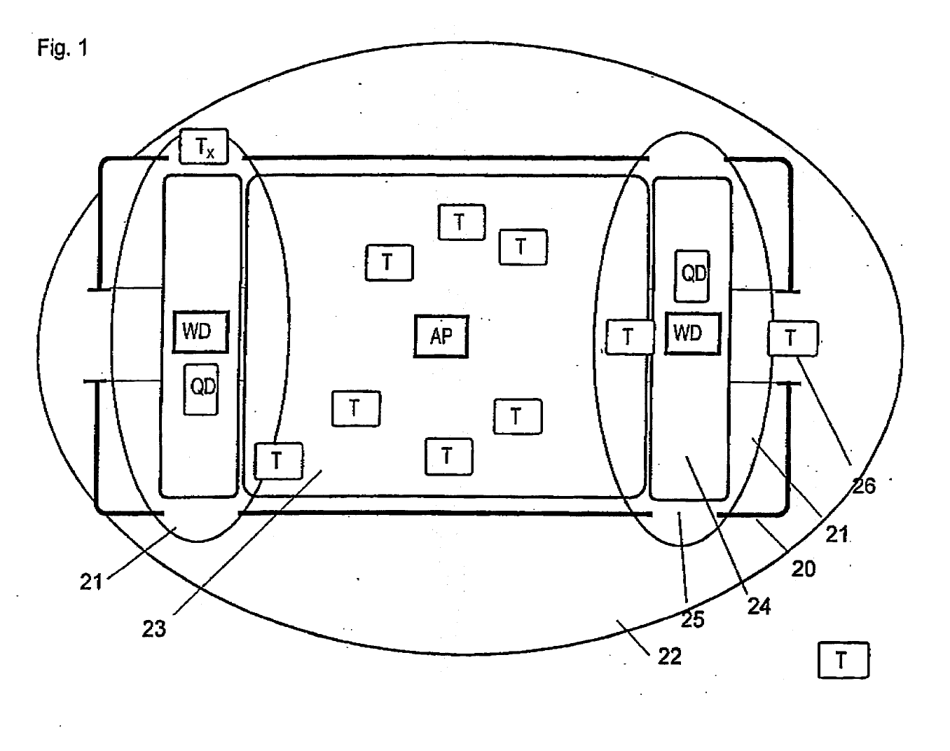

FIG. 1 shows the plan of a train car 20 having an entrance area 25, located at each of the ends of the wagon, and a passage area 26. These two areas 25 and 26 enable access, via platform 24, to passenger compartment 23. For reasons of clarity, doors are not depicted in the drawing. The platform 24 and the seating compartment 23 may be open or built with a wall and an associated door. A first sending unit WD is associated with each of the two platforms 24 and covers the corresponding entrance zone 21 with an electromagnetic field which is developed as a so-called near field having preferably a frequency of 6.75 MHz or 13.5 MHz. A second sending/receiving unit AP is associated with the seating compartment 23 and covers detection zone 22 with an electromagnetic field, the communication therein occurring preferably in the frequency area of 868 MHz or 433 MHz. The given zones correspond approximately to the coverage in regard to a minimal field intensity of the concerned sending units WD and AP.

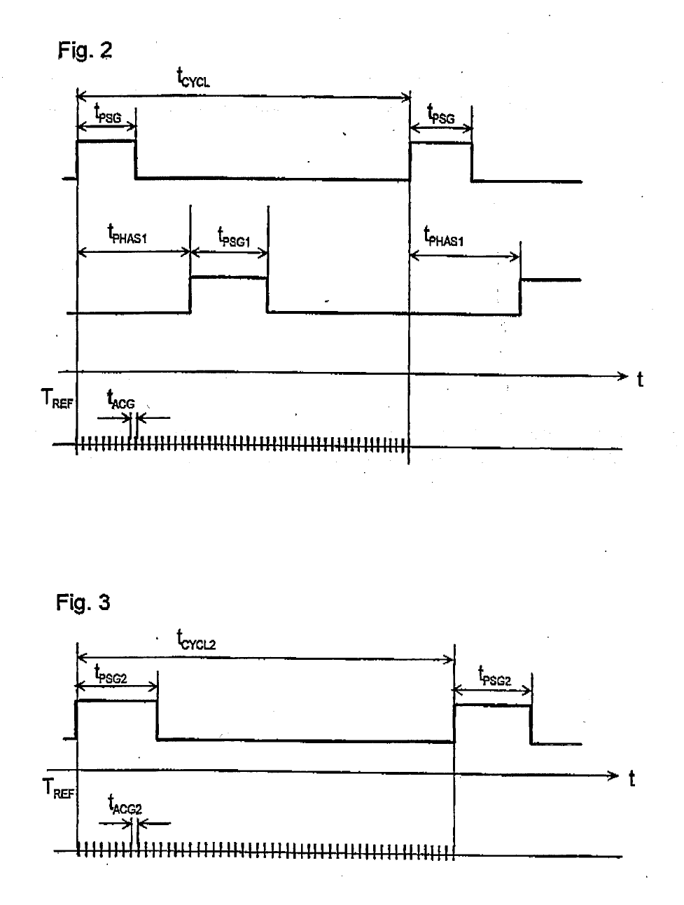

It is assumed that a ticket T_{X} is located in an energy saving “sleep mode”, i.e. only its first receiving module is ready to receive. If a person with ticket T_{X} approaches the entrance area 25 of train car 20, this person comes into the so-called entrance zone 21 and therefore in the near field range of the sending unit WD. A first receiving module exists on the ticket T_{X}, which receives an information unit INF1 from the sending unit WD which contains a time reference and a time slot pattern t_{PSG} and t_{CYCL}. The time reference is preferably defined by a 24 bit number as well as a phase value to the next and in particular first whole time slot pattern. By receiving the information unit INF1, the ticket T_{X} is “woken up”, i.e. an intermittent engagement of the second sending/receiving module located on the ticket is effected. The cycle associated with this is disclosed in FIG. 2 wherein the time reference is given by the ordinate at point T_{REF}. This process of alarming and intermittent engaging happens with all tickets which reach the entrance zone 21 or are located within it. The definition of time reference and time slot pattern t_{CYCL}, t_{PSG} on the tickets T can also take place in a different way than as described above; a fixed time reference and/or fixed time slot pattern is possible. Preferably, the time reference is dependent on an identity associated parameter of the corresponding detection zone. This parameter can also be determined by the second sending/receiving unit, this is especially advantageous then when more than one second sending/receiving unit is associated to a wagon. The fixation of the previously mentioned parameter can occur with a general broadcast message from the corresponding second sending/receiving unit, details of which are described further in the description. An example of a possible structure of the information unit INF1 can be gathered from the following table 1, wherein additional parameters are indicated with PARAM1, PARAM2:

TABLE 1

| Information field | Meaning |
|---|---|
| COMMAND1 | Order to the ticket T |
| CYCL | Duration of cycle |
| PSG | Duration of receiving readiness |
| REFCOUNT | Reading of time meter |
| REFPHASE | Units of the time meter until T_{REF} |
| BROADCAST_LENGTH | Length of broadcast |
| PARAM1 | Application parameter 1 |
| PARAM2 | Application parameter 2 |

A quittance device QD (FIG. 1) is associated with the second sending/receiving unit AP within the detection zone 22. The quittance device QD is preferably designed like a ticket T and is permanently supplied with power by the infrastructure of the train wagon.

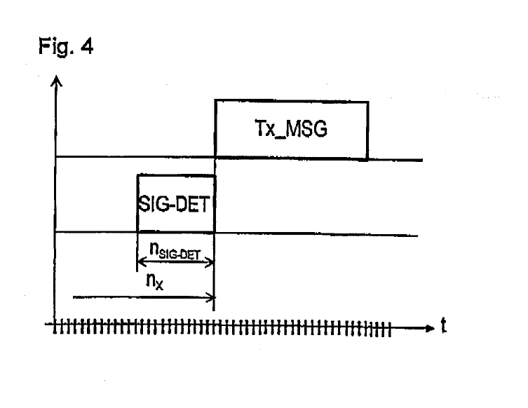

The second sending/receiving unit AP is provided with a circuit, which allows for measuring the signal strength before sending out a message. The circuit is used to determine if the radio medium is busy or not, according to the RSSI (received signal strength indication) as CS (carrier sense) or as signal detection SIG-DET. The same process for the signal detection SIG-DET is also carried out on the ticket side and is depicted in FIG. 4 with Tx_MSG for the presence message to be sent and with SIG-DET for the signal detection; x stands for the number, in particular an index, of a ticket, x=1, 2, . . .

An embodiment of the method according to the invention is now set out in more detail according to the layout of FIG. 1 with the operations depicted in the FIGS. 2 through 4. It is denoted:

| | |
|---|---|
| AP | Second sending/receiving unit AP (access point); |
| T1, T2, T3 | three different tickets T in the detection zone 22 of |
| | the corresponding second sending/receiving unit AP; |
| QD | Quittance device associated to the second |
| | sending/receiving unit AP; |
| t_{ACG} | Anti collision Grid; |
| t_{CYCL} | Cycle time for intermittent operation; |
| t_{LAT} | Latency time for an outstanding quittance message |
| | ACK_Tx; |
| t_{PHAS1} | Timed dephasing for an alternative on/off switching |
| | cycle with the same parameter (check this) tcYCL |
| | and tPSG; |
| t_{PSG} | Duty cycle within the cycle time tcYCL; |
| TREF | Time reference for all parties located in the detection |
| | zone 22 (Tx, AP, QD); |
| AP_BC | Broadcast; |
| QD_ACK | Quittance message of the device QD to the second |
| | sending/receiving unit AP; |
| ACK_T1, | Quittance message to the corresponding ticket T1, |
| ACK_T2, | T2, T3; |
| ACK_T3 | |
| T1_MSG, | Presence message of the tickets T1, T2, T3. |
| T2_MSG, | |
| T3_MSG | |

The on/off switching cycle is set out in a non-proportional depiction in FIG. 2 for the second receiving module on a ticket T. The indicated times adjust to the application, as by way of example, the following values are shown: t_{CYCL}=360 s and t_{PSG}=60 ms for the detection in an intercity train corresponding to the duty cycle of 1/6000; t_{CYCL}=30 s and t_{PSG}=30 ms for the detection in a bus corresponding to the duty cycle of 1/1000. If a ticket T does not receive a broadcast message AP_BC during a determined number—for example 5, the ticket returns to the previously mentioned sleep mode. In FIG. 2 the anti-collision grid is disclosed with a width of t_{ACG}. t_{CYCL} and t_{ACG} are preferably connected with each other by an integral multiple according to the following examples: t_{CYCL}=n* ACG, n=1000 . . . 60000; according to the second previously mentioned example t_{CYCL}=30 s, n=6000 amounts to: t_{ACG}=5 ms. It is also possible to parameterize, in particular determine, the size of t_{ACG} from t_{PSG}. According to the application it can also be purposeful to use a value for n which lies outside of the previously mentioned example interval of 1000 . . . 60000.

For an assumed radio transmission capacity of 80 kbit/s an information quantity is accrued from the 3 units of the anti-collision grid of t_{ACG}=5 ms:80 kbit/s 5 ms=400 Bit for a unit; 3·400 Bit=150 Byte are accrued from 3 units, whereby 8 Bit=1 Byte. 15 ms are therefore necessary for a transmission of 150 Byte; the net transmission rate is lower because a part is necessary for a safety layer.

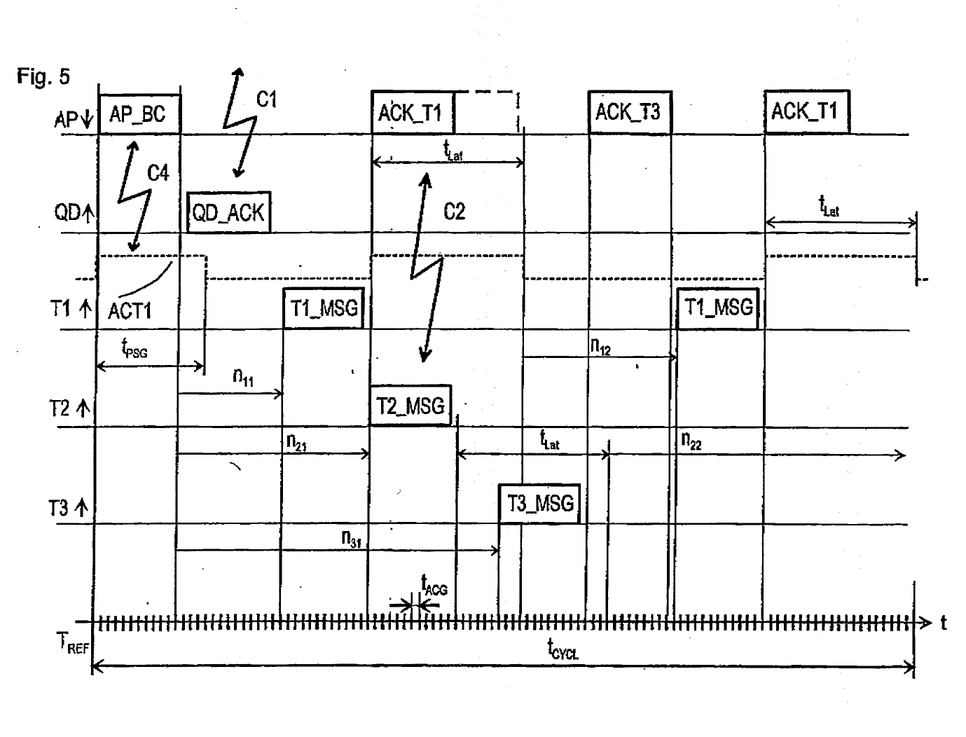

In FIG. 5, the reference T_{REF}, known to the tickets T and the second sending/receiving unit AP, is disclosed. Within the duration t_{PSG} according to FIG. 2 the second sending/receiving unit AP sends a broadcast message AP_BC. A possible structure of the broadcast message AP_BC can be seen in table 2, wherein:

TABLE 2

| Information field | Meaning |
|---|---|
| COMMAND | Command to the ticket T |
| REFCOUNT | Reading of time counter |
| REFPHASE | Units of the time meter until TREF |
| POSITION | Position |
| COURSE | Course number |
| TYPE | Type of the vehicle |
| PARAM1 | Application parameter 1 |
| PARAM2 | Application parameter 2 |

In the field COMMAND the information contained may be that the ticket which received this message must send back a so-called presence message Tx_MSG; if no presence message has been sent back, the broadcast message for the corresponding ticket can have the function of a so-called staying awake call. The fields REFCOUNT and REFPHASE can be used at this message to synchronize the time reference of the ticket. This may be necessary because normally there are no highly precise clock generators available on the tickets T. A drift of the on/off switching cycle is thereby avoided. The alerting call can occur in a periodicity m t_{CYCL}; whereby the following values are allowed for m: m=1, 2, . . . , (Nₘₐₓ−1); Nₘₐₓ stands for the maximum number of cycles, after which a ticket T returns to sleep mode during unsuccessful communication with a sending unit WD or AP.

A quittance device QD associated to the second sending/receiving unit AP (FIG. 1) acknowledges in the collision free case the broadcast message AP_BS with a quittance message QD_ACK to the second sending/receiving message AP. The time which is necessary for the transmission comes out to a number of units in the length of t_{ACG} known to the tickets T, this number is for example defined as a fixed value or in an additional field of the first information unit INF1. The identity of the second sending/receiving message AP is advantageously contained in the quittance messages, that it can be conclusively decided, if the sent out broadcast message AP_BC was received by the quittance device QD. Additionally or alternatively, it is also possible that the quittance device QD only acknowledges such broadcast messages AP_BC which coincide with the identity known to the quittance device QD of the second sending/receiving unit AP.

In FIG. 5 it is first assumed that all three tickets T1, T2 and T3 have received the broadcast message AP_BC. A random generator is provided for the tickets Tₓ with x=1, 2 or 3, which produces random numbers nₓ₁, nₓ₂, nₓ₃ up to n=1000 . . . 60000. In the following, the time data and random numbers nₓᵢ are connected with each other as follows: tₓᵢ=nₓᵢ·t_{ACG}. The random numbers nₓᵢ are greater than the number of units t_{ACG} associated with the time t_{LAT} and clearly smaller than the time t_{CYCL} and corresponding number of units t_{ACG}. The algorithm for the production of random numbers on ticket Tₓ is preferably:

Nₓᵢ:=zₓ·Nₓᵢ+bₓ, whereby nₓᵢ is disclosed as an integral value.

Zₓ may be a random number in the interval between 0 and 1, and for example in a discrete 16 bit representation. The index x means that the random number is ticket specific and therefore produced in dependence of ticket Tₓ. The starting value of the random number generator can be for example determined by a parameter associated with the ticket identity. Nₓᵢ is an integral upper limit of the numerical range for the random numbers to be generated, the sequence Nₓᵢ, Nₓ₂, Nₓ₃ . . . , is strictly monotonously or monotonously increasing up to the previously mentioned value, until the ticket Tₓ receives an acknowledgement ACK_Tx; this monotony is described as the so-called “exponential back off”. The probability of further collision is thereby reduced.

Bₓ is a positive integer constant to assure a minimal size of the number nₓᵢ. Contrary to the depiction of FIG. 5, it is possible from the messages T1_MSG, T2_MSG and T3_MSG that bₓ is selected for further attempts wherein the latency time t_{LAT} is also considered, meaning that the number nₓᵢ (i>1) contains the number of units t_{ACG} of the anti-collision algorithm from the time of sending out a presence message Tx_MSG. This last case is disclosed in FIG. 5 at the end of the message AP_BC.

Because the corresponding starting value of the random generator is defined by a ticket specific parameter, it is independent from the number of tickets located in the detection zone 22 and not possible for an identical sequence of numbers to be generated on two tickets. Collisions, however, are still possible and these cases are disclosed in detail below.

With the so defined random numbers n₁₁, n₂₁ and n₃₁ it is provided that the tickets set off a presence message T1_MSG, T2_MSG and T3_MSG to n₁₁, n₂₁ and n₃₁ units of the anti-collision grid t_{ACG}. Whether a presence message is actually sent out is determined by the signal detection SIG-DET according to FIG. 4. The presence message Tx_MSG is only sent out then, when the radio medium is available during a fixed number of units n_{SIG-DET}. Because each ticket Tₓ expects an acknowledgment message ACK_Tx immediately after setting off a presence message Tx_MSG, the sending/receiving module is additionally connected, active, to the intermittent cycle TCYCL/TPSG, for the duration of the latency time. This is depicted in FIG. 5 with ACT1 with its associated rectangle. The quittance message ACK_Tx contains the address of the corresponding ticket Tₓ. If by chance another ticket T_{y} receives such an acknowledgement message ACK_Tx, this message is rejected. However, it is possible that, because the expected sender is also contained in this acknowledgement message ACK_Tx, a ticket T_{y} uses single fields of this message for a resynchronization of the clock generator located on ticket T_{y}.

Possible collisions and their management are disclosed in the following collision case C1 according to FIG. 5. The second sending/receiving unit AP does not receive a quittance message QD_ACK by the quittance device and repeats for a determined number of units the sending out of a broadcast message AP_BC according to the determined cycle t_{CYCL} and t_{PSG}. If the collision is repeated during a certain number of cycles t_{CYCL}, it is provided in another embodiment of the invention that the second sending/receiving unit PA sends out a broadcast message AP_BC to an opposing T_{REF} by the phase t_{PHAS1} offset time. This by phase t_{PHAS1} offset grid is known to the tickets T for example by the content of the information unit INF1 or INF2.

Collision case C2 according to FIG. 5. This case can occur during a parallel ride of two buses. It cannot be avoided that the detection zones 22 defined by the spreading of the electromagnetic fields overlap. This overlapping as such does not cause an automatic collision because of the preferably wagon specific determined on/off switching cycle. Conditioned on the duration of transmission, of for example 15 ms, the following collisions are for example possible:

a) With the signal detection SIG-DET, cases are not detected where the ticket Tₓ to be sent sends out a message TX_MSG almost at the same time as for example the second sending/receiving unit AP sending off an acknowledgement message ACK_Ty.

b) In addition, with the signal detection SIG-DET nearly simultaneously sent messages can also not be recognized which collide with other second sending/receiving unit AP or tickets T which are not associated to the corresponding detection zone 22. Accordingly, it is to considered that first the sending capacity of the tickets Tₓ is lower, and second essentially lower levels occur because of the spatial distance and the wall absorption. The probability of a collision between a wagon-external ticket T and an internal wagon second sending/receiving unit AP is thereby reduced, but not excluded.

In the present collision case C2, depicted in FIG. 5, neither ticket T2 nor ticket T1 receives an acknowledgement message ACK_T2 or ACK_T1 for the sent out presence messages T2 MSG and T1 MSG. After a latency time t_{LAT}, each ticket sends out again a presence message T2_MSG and T1_MSG after n₂₂ and n₁₂ units of the anti-collision grid t_{ACG}.

Collision case C3 is not depicted in the figures. This case may occur at the intersection of two vehicles with total combined velocity of approx. 300 km/h or more. The relative speed of the trains amounts to the difference of the absolute speed, which signs corresponds to the direction of the trains. This collision case compared to the collision case 1 is either not different or leads to an incomplete transmission. An incomplete transmission is recognized by a transportation data link layer, for example by a check sum, and can be eliminated with a repeated sending off of a message (from or to the ticket) according to the invention.

Collision case C4 will be discussed with reference to FIG. 5. Herein, when an additional second sending/receiving unit of a neighboring wagon is present and sends off a broadcast message so closely to the time TREF, it may no longer be recognized by the signal detection SIG-DET. Conditioned on each individual wagon determined on/off switching cycles, this collision is eliminated by either a repeated sending out at a later (by a multiple of t_{CYCL} determined) time or by a change-over to a on/off switching cycle offset by phase TPHAS1. A continuous interference is especially possible in this case, as for example caused by a carrier signal of the determined first frequency. In a further embodiment of the invention, such a collision is met in that it resorts to a second frequency on the ticket T as well as on the side of the second sending/receiving unit AP. On/Off switching cycles and possibly the determination of a second frequency can be contained in the information unit INF1 in the additional fields PARAM1, PARAM2, . . . . The tickets T are therefore able to change onto the other frequency from the first or only after a determined number of cycles t_{CYCL}. If the first frequency is at 868 MHz, it is advantageous to select the second frequency as being about ±500 kHz from the first frequency.

An alternative second on/off switching cycle is disclosed in FIG. 3. The on/off switching cycle can adaptively be turned off Additionally to broadcast messages AP_BC, the second sending/receiving unit sends, periodically, for example each 7^{th} t_{CYCL} cycle, a so-called stay awake call. The structure of such a call is similar to the one in the broadcast message and can be distinguished for example in the field COMMAND. For example, the symbolic values “answer”, “synchronization” “new cycle” can be listed alternatively or cumulatively in the field “command of the information unit INF2”. With the staying awake call (and the broadcast message), it is communicated to the tickets T that they are still located in the detection zone 22 and a counter is set on an initial value on the tickets T. This counter is reduced by 1 with the expiration of each period t_{CYCL} When the counter reaches the value zero, the corresponding ticket T is put into the sleep mode. It is also possible to set the counter to zero at receipt of a stay awake call or a broadcast message and to count up in each case by the value of 1 to a final value.

In the design of a wagon, the first sending unit WD and the second sending/receiving unit AP can be combined into a unit such as terminal; it is also possible to build in the quittance device QD, at a minimal distance, into such a terminal, as well.

As disclosed in FIG. 1, two quittance devices QD can be alternatively associated to a second sending/receiving unit AP. In an additional embodiment of the invention, it is provided that the second sending/receiving unit AP first expects two quittance messages QD_ACK. If only one or even any quittance message QD arrives, another broadcast message AP_BC is sent out in the next cycle. This process can, for example, be repeated for 2 to 4 cycles, whereby 4<Nₘₐₓ, Nₘₐₓ standing for the maximum number of cycles, after which a ticket 10 returns into the sleep mode without receipt of a broadcast message AP_BC. It can be provided with the additional cycles 5, 6 . . . that the arrival of a quittance message QD_ACK is sufficient as far as no further broadcast messages are sent out. This case can happen, if a partial overlap with the detection zone of another wagon occurs.

The invention being thus described, it will be obvious that the same may be varied in many ways. For example, the present method is not limited to public transportation. Rather, it may also be used for tracking and detection of objects which are provided with a smart card having a sending/receiving module. It is also possible to register persons in buildings, for example in certain zones in a museum or in especially secure areas. Such variations are not to be regarded as a departure from the spirit and scope of the invention, and all such modifications as would be obvious to one skilled in the art are intended to be included within the scope of the following claims.

We claim:

1. A method for managing collisions in a wireless detection system, said system comprising a plurality of receivers having a sending receiving module and at least one sending receiving unit for intermittent communication, via an on off switching cycle within a cycle, with said receivers located in a detection zone, comprising the steps of:
transmitting a broadcast message from said sending receiving unit to at least one receiver and transmitting a quittance message to said sending receiving unit from a quittance device associated with said detection zone;
transmitting a presence message identifying said at least one receiver to said sending receiving unit, said message being transmitted by said at least one receiver upon receipt of said broadcast message, said message being transmitted after a time determined by a random generator;
transmitting an acknowledgement message from said sending receiving unit to said at least one receiver, said acknowledgement message acknowledging receipt of said presence message; and
if a collision occurs in the communication between said at least one receiver and said sending receiving unit, said collision is eliminated by:
repeating said step of transmitting a broadcast message if said quittance message is not received by said at least one receiver within a select cycle; and
repeating said step of transmitting a presence message, at a random time generated by a random generator, if said acknowledgement message is not received by said at least one receiver within a latency time after said step of transmitting a presence message.

2. The method according to claim 1, wherein messages are only transmitted if prior to transmission an indication that a radio medium is available is detected.

3. The according to claim 1, further comprising the step of increasing the upper limit of the random generator with each repetition of said step of repeating said step of transmitting.

4. The according to claim 2, further comprising the step of increasing the upper limit of the random generator with each repetition of said step of repeating said step of transmitting.

5. The method according to claim 1, wherein said on off switching cycle and said cycle are individually determined by said sending receiving unit.

6. The method according to claim 4, wherein said on off switching cycle and said cycle are individually determined by said sending receiving unit.

7. The method according to claim 1, wherein said cycle is integrated into an anti-collision grid, whereby said cycle is a multiple of said anti-collision grid and message transmitted at transmission times determined by anti-collision grid.

8. The method according to claim 6, wherein said on off switching cycle and said cycle are individually determined by said sending receiving unit.

9. The method according to claim 1, wherein another on off switching cycle is associated with said cycle.

10. The method according to claim 8, wherein another on off switching cycle is associated with said cycle.

11. The method according to claim 1, further comprising the steps of altering said on off switching cycle in response to a transmission of said broadcast message from said sending receiving unit to said at least one receiver located in said detection zone.

12. The method according to claim 10, further comprising the steps of altering said on off switching cycle in response to a transmission of said broadcast message from said sending receiving unit to said at least one receiver located in said detection zone.

13. The method according to claim 1, further comprising the steps of resynchronizing a clock generator located in said at least one receiver upon transmission of said broadcast message.

14. The method according to claim 12, further comprising the steps of resynchronizing a clock generator located in said at least one receiver upon transmission of said broadcast message.

15. The method according to claim 1, wherein said communication is set up upon an alternative cycle if a collision is detected.

16. The method according to claim 14, wherein said communication is set up upon an alternative cycle if a collision is detected.

17. The method according to claim 15, wherein said alternative cycle is integrated into a second anti collision grid wherein a second anti collision grid cycle is a multiple of said second anti collision grid and messages are transmitted at times according to said second anti collision grid.

18. The method according to claim 1, wherein said communication is set up upon another frequency if a collision is detected.

19. Method according to claim 1, wherein times produced by said random generator are dependant upon identity of a corresponding receiver.

20. The method according to claim 17, wherein said communication is set up upon another frequency if a collision is detected and wherein times produced by said random generator are dependant upon identity of a corresponding receiver.
